(19) United States
(12) Patent Application Publication
(10) Pub. No.: US 2006/0147485 A1
(43) Pub. Date: Jul. 6, 2006

(54) Oil-in-water formulation of avermectins

(76) Inventors: Morten Pedersen, Lemvig (DK); Henriette Sie Woldum, Lemvig (DK)

Correspondence Address: JACOBSON HOLMAN PLLC, 400 SEVENTH STREET N.W., SUITE 600, WASHINGTON, DC, 20004, US

(21) Appl. No.: 11/028,507

(22) Filed: Jan. 4, 2005

(51) Int. Cl. A01N 43/04

(52) U.S. Cl. 424/405; 514/28

(57) ABSTRACT

Oil-in-water emulsion formulations (EW) of avermectins based on phthalates as organic solvent and the use of such formulations for the control of pests.

The present invention relates to oil-in-water emulsion formulations (W) of avermectins based on phthalates as organic solvent and to the use of such formulations for the control of pests.

### BACKGROUND

Abamectin is a compound belonging to the well known class of avermectins which are a group of macrocyclic compounds derived from fermentation products from a strain of Streptomyces avermitilis possessing potent anthelmintic and insecticidal activities. The individual avermectins, either naturally derived or prepared by synthetic means, are usually mixtures of up to 8 major components designated as A₁ₐ, A_{1b} A₂ₐ, A_{2b}, B₁ₐ, B_{1b} B₂ₐ, B_{2b} in various ratios. For instance Abamectin is a mixture of the two closely structurally related components designated B₁ₐ and B_{1b} usually in a 80:20 ratio, whereas the active compound known as Aversectin C further comprises additional components in addition to those in Abamectin.

Abamectin is commercially available in the form of emulsifiable concentrates (EC), i.e. formulations wherein the active ingredient is emulsified in an organic solvent. From an environmental point of view such formulations are however not desirable due to the large amount of organic solvent used. In addition, the EC product comprising Abamectin sold under the trademark Vertimec, makes use of N-methyl-2-pyrrolidone which is suspected of being teratogenic. It would thus be desirable to provide the active ingredient in a more environmental and user friendly form, e.g. substitution of the organic solvent totally or in part with water. Such preparations are also attractive from an economical point of view.

Oil-in-water formulations significantly reduces the amount of solvent used, but as disclosed by Mosin et at (Russian Journal of Ecology, Vol. 29, No. 2 1998, pp 127-129) Aversectin C for example tends do degrade significantly over time in the presence of water and even a faster degradation is observed if exposed to light as disclosed by Wislocki et al in Ivermectin and Abamectin, Cambell, W. C.; Ed, New York: Springer-Verlag, 1989, especially pp. 184-185.

In European patent publication no. EP 1210877-A1 and PCT publication no. WO 02/43488-A1 it is suggested to formulate various insecticides, in particular pyrethroids, as oil-in-water emulsions using one or more solvents from the group of esters of aliphatic monocarboxylic acids, esters of aliphatic dicarboxylic acids, esters of aromatic monocarboxylic acids, esters of aromatic dicarboxylic acids and tri-n alkylphosphates; an emulsifier system comprising one or more anionic surfactants and two or more non ionic surfactants; and one or more film forming agents/thickeners; and water. Such preparations are said to be stable, but no teaching as to the stability of the active ingredient(s) itself is found in the specifications.

PCT publication no. WO 95/31898-A1 discloses formulations of various insecticides, in particular pyrethroids, as oil-in-water emulsions using one or more solvents from the group of esters of phthalates or fatty esters derived from vegetable oils, and an aqueous phase comprising an silica derivative. However, it is not suggested that the compositions have a beneficial effect on the stability of the active ingredient(s) itself.

In U.S. Pat. No. 5,227,402 aqueous microemulsion formulations of Abamectin are disclosed (e.g. example 11). Although the formulations are said to be stable, no teaching as to the stability of the active ingredient itself is found in the specifications. In addition, the exemplified use of cyclohexanone as organic solvent does comprise a hazard to the environment.

Further, microemulsions require use of large amounts of surfactants to ensure stability of the nanodroplets in the aqueous phase and such large amounts of surfactant tends to increase the risk of skin penetration and as such comprise a hazard during handling. Whereas microemulsions appear throughout as transparent or semitransparent preparations with oil droplets usually of a magnitude of 10-200 nm, oil-in-water emulsions are non-transparent and the oil droplets of a magnitude of 1-20 μm.

In European patent specification no. EP 45655-A2, stable microemulsions of Ivermectin suitable for parental or oral administration are provided using co-solvents selected among glycerol formal, propylene glycol, glycerin or polyethylene glycol. The microemulsions can be further stabilised with inclusion of one or more substrates selected among benzyl alcohol, lidocaine, a paraben or choline.

It has now surprisingly been found that EW-formulations of avermectins with significant stabilisation of the avermectin compound itself can be prepared based on phthalates as organic solvent.

### DESCRIPTION OF THE INVENTION

In one aspect of the present invention oil-in-water emulsion formulations (W) are provided comprising

a) one or more pesticidal active ingredients selected among avermectins

b) one or more organic solvents selected among phthalates

c) an emulsifier system comprising one or more surfactants

d) water

The formulations according to the invention provide a significant stabilization of the active ingredients compared to oil-in-water formulations comprising avermectins according to the prior an and maintain the benefits of oil-in-water emulsions. Further, the formulations significantly reduce the degradation of the avermectin(s) also when exposed to light.

As such the present invention provides a method for stabilising avermectins in oil-in-water emulsion formulations using the above composition. Preferably the formulations provide stabilisation of the avermectin(s) to an extent that less than 5%, more preferably 3%, of the initial concentration of the avermectin(s) has degraded when the formulations are stored at 54° C. for 14 days; or less than 10%, more preferably 5%, of the initial concentration of the avermectin(s) has degraded when the formulations are stored at 70° C. for 14 days.

The avermectin(s) is e.g. selected among Abamectin, Aversectin C, Doramectin, Emamectin (optionally in the form of its benzoate salt), Eprinomectin, Ivermectin and Selamectin and especially selected among Abamectin. Aversectin C, Ivermectin and Emamectin (optionally in the form of its benzoate salt) with Abamectin being the most preferred choice.

For the purpose of this invention, all percentages expressed herein are percentage by weight, unless otherwise specified.

The concentration of the avermectin is generally between 0.001 to 30%, preferably 0.1 to 10%, and more preferably 1 to 5%.

The phthalate(s) used as organic solvent is chosen among dialkyl or alkyl aryl esters of 1,2-benzenedicarboxylic (it being understood that the alkyl or alkyl aryl groups may the same or different and the alkyl groups linear or branched) and include diethylhexyl phthalate, ethylhexyl phthalate, dimethyl phthalate, diethyl phthalate, butylbenzyl phthalate, dibutyl phthalate, diisononyl phthalate, and dioctyl phthalate. Preferred are dimethyl phthalate, diethyl phthalate and diisononyl phthalate and especially diethyl phthalate.

The amount of phthalate is generally between 10 to 60%, preferably 20-50%.

The emulsifier system comprising one or more surfactants is chosen among anionic, cationic, nonionic, zwitterionic and polymer surfactants or mixtures thereof.

Examples of suitable anionic surfactants include alkali, alkaline earth or ammonium salts of the fatty acids, such as potassium stearate, alkyl sulfates, alkyl ether sulfates, alkylsulfonates or iso-alkylsulfonates, alkylbenzenesulfonates such as sodium dodecylbenzenelsulfonate, alkylnaphthalenesulfonates, alkyl methyl ester sulfonates, acyl glutamates, alkylsulfosuccinates, sarcosinates such as sodium lauroyl sarcosinate, taurates or ethoxylated and phosphorylated styryl-substituted phenols. Examples of suitable cationic surfactants include halides or alkyltrimethylammonium alkyl sulfates, alkylpyridinium halides or dialkyldimethylammonium halides or dialkyldimethylammonium alkyl sulfates. Examples of suitable nonionic surfactants include alkoxylated animal or vegetable fats and oils such as corn oil ethoxylates, castor oil ethoxylates, talo fat ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononylphenol ethoxylates, fatty amine alkoxylates, fatty acid amide alkoxylates, sugar surfactants such as sorbitan fatty acid esters (sorbitan monooleate, sorbitan tristearate), polyoxyethylene sorbitan fatty acid esters, allyl polyglycosides, ethoxylated styryl-substituted phenols, N-alkylgluconamides, alkylmethyl sulfoxides, alkyldimethylphosphine oxides such as tetradecyldimethylphosphine oxide.

Examples of suitable zwitterionic surfactants include alkylbetaines, alkylamidobetaines, amino-propionates, aminoglycinates, imidazolinium betaines and sulfobetaines.

Examples of polymer surfactants include di-, tri- or multi-block polymers of the (AB)x, ABA and BAB type, such as polyethylene oxide block polypropylene oxide, polystyrene block polyethylene oxide, AB comb polymers such as polymethacrylate comb polyethylene oxide or polyacrylate comb polyethylene oxide.

The surfactants mentioned are all known compounds.

The amount of surfactant in the formulations is generally between 0.1-20%, preferably between 0.5-15% and more preferably between 1-10%.

It is preferred to use as emulsifier system, one or more surfactants selected among anionic surfactants, more preferably ethoxylated and phosphorylated styryl-substituted phenols and alkyl ether sulfates.

Further optionally auxiliaries which may be included in either the organic or aqueous phase (depending on solubility) include co-solvents, pH-adjusters, thickeners, film-forming agents, antifreeze agents, preservatives, antifoaming and defoamer agents, spreading agents, stickers, wetting agents, structuring agents, UV-protectants and one or more additional insecticides. Such auxiliaries are generally known within the art of formulation chemistry, and although a specific ingredient is classified as falling within one category, it may well serve the purpose of any of the others.

Suitable co-solvents include mineral oils and vegetable oils, e.g. avocado oil, coconut oil, rape seed oil, maize oil, sesame oil, olive oil, soybean oil, palm oil, grape seed oil, almond oil, linseed oil, peanut oil, walnut oil, tall oil, thistle seed oil, wheat germ oil, sunflower oil, poppy-seed oil, cottonseed oil, persic oil, apricot oil, jojoba oil, castor oil and sesame oil.

The pH adjusters include both acids and bases of the organic or inorganic type. Suitable pH adjusters include organic acids and alkali metal compounds. The organic acids include those such as citric, malic, adipic, cinnamic, fumaric, maleic, succinic, and tartaric acid, and the mono-, di-, or tribasic salts of these acids are suitable organic acid salts. Suitable salts of these acids are the soluble or meltable salts and include those salts in which one or more acidic protons are replaced with a cation such as sodium, potassium, calcium, magnesium, and ammonium. Alkali metal compounds include hydroxides of alkali metals such as sodium hydroxide and potassium hydroxide, carbonates of alkali metals such as sodium carbonate and potassium carbonate, hydrogencarbonates of alkali metals such as sodium hydrogencarbonate and alkali metal phosphates such as sodium phosphate.

The amount of addition of pH adjuster to the composition is at one's option, but it has been found that the pH value of the emulsions, i.e. prior to dilution, to some extent have an influence on the stability of the avermectin, and the optional pH adjusters are suitably present in amounts to ensure a pH-value of the emulsions from 3 to 10, preferably 4-9 and even more preferably 5-8. However, one need not necessarily add pH adjusters as the emulsifier system by itself or the optionally auxiliaries, depending on choice of components, may ensure that the pH-value is within the preferred range.

Thickeners and film-forming agents include starches, gums, casein and gelatine, polyvinyl pyrrolidones, polyethylene and polypropylene glyols, polyacrylates, polyacrylamides, polyethyleneimines, polyvinyl alcohols, polyvinyl acetates, and methyl-, hydroxyethyl- and hydroxypropylcelluloses and derivatives thereof.

Examples of the antifreezing agent include ethylene glycol, diethylene glycol, propylene glycol and the like.

Typical preservatives include methyl and propyl parahydroxybenzoate, 2-bromo-2-nitro-propane-1,3-diol, sodium benzoate, formaldehyde, glutaraldehyde, O-phenylphenol, benzisothiazolinones, 5-chloro-2-methyl-4-isothiazolin-3-one, pentachlorophenol, 2-4-dichlorobenzylalcohol and sorbic acid and derivatives thereof.

Preferred anti-foaming and defoamer agents are silicone based compounds e.g. polyalkylsiloxanes.

The optional additional insecticide (including acaricides and nematicides) can advantageously be included for example to widen the spectrum of action or to prevent the build-up of resistance. Suitable examples of such additional insecticides are e.g.:

acephate, acetamiprid, acrinathrin, alanycarb, aldicarb, alphamethrin, amitraz, azadirachtin, azinphos, azocyclotin,

Bacillus thuringiensis, bendiocarb, benfuracarb, bensultap, betacyfluthrin, bifenazate, bifenthrin, bistrifluron, BPMC, brofenprox, bromophos, bufencarb, buprofezin, butocarboxin, butylpyridaben,

cadusafos, carbaryl, carbofuran, carbophenothion, carbosulfan, cartap, chloethocarb, chloroethoxyfos, chlorfenapyr, chlorofenvinphos, chlorofluazuron, chloromephos, chlorpyrifos, chromafenozide, cis-resmethrin, clothianidin, clocythrin, clofentezine, cyanophos, cycloprothrin, cyfluthrin, cyhalothrin, cyhexatin, cypermethrin, cyromazine,

deltamethrin, demeton, difenthiuron, diazinon, dichlofenthion, dichloivos, dicliphos, dicrotophos, diethion, diflubenzuron, dimetboate, dinethylvinphos, dinotefuran, dioxathion, disulfoton,

edifenphos, esfenvalerate, ethiofencarb, ethion, ethofenprox, ethoprophos, etoxazole, etrimphos,

fenamiphos, fenzaquin, fenbutatin oxide, fenitrothion, fenobucarb, fenothiocarb, fenoxycarb, fenpropathrin, fenpyrad, fenpyroximate, fenthion, fenvalerate, fipronil, flonicamid, fluazinam, fluazuron, flucycloxuron, flucythrinate, flufenoxuron, flufenprox, fluvalinate, fonophos, formothion, fosthiazate, fubfenprox, furathiocarb,

gamma-cyhalothrin,

HCH, heptenophos, hexaflumuron, hexythiazox,

imidacloprid, indoxacarb, iprobenfos, isazophos, isofenphos, isoprocarb, isoxathion,

lambda-cyhalothrin, lufenuron,

malathion, mecarbam, mevinphos, mesulfenphos, metaldehyde, methacrifos, methamidophos, methidathion, methiocarb, methomyl, methoxyfenozide, metolcarb, milbemectin, monocrotophos, moxidectin,

naled, nitenpyram,

omethoate, oxamyl, oxydemethon M, oxydeprofos,

parathion A, parathion M, permethrin, phenthoate, phorate, phosalone, phosmet, phosphamidon, phoxim, pirimicarb, pirimiphos, profenofos, promecarb, propaphos, propoxur, prothiofos, prothoate, pymetrozin, pyrachlophos, pyridaphenthion, pyresmethrin, pyrethrum, pyridaben, pyrimidifen, pyriproxifen,

quinalphos,

salithion, sebufos, silafluofen, spinosad, spirodiclofen, sulfotep, sulprofos,

tebufenozid, tebufenpyrad, tebupirimiphos, teflubenzuron, tefluthrin, temephos, terbam, terbufos, tetrachlorvinphos, thiacloprid, thiafenox, thiamethoxam thiodicarb, thiofanox, thiomethon, thionazin, thuringiensin, tralomethrin, triarathen, triazophos, triazuron, trichlorfon, triflumuron, trimethacarb,

vamidothion, XMC, xylylcarb, zetamethrin.

It is preferred to include one or more insecticides chosen among the natural or synthetic pyrethroids e.g. as found above and especially chosen among acrinathrin, cypermethrin, cyfluthrin, cyhalothrin, deltamethrin, fenvalerate and tefluthrin, including any of the previous mentioned compounds in its partially or fully resolved isomeric form. Particularly preferred is acrinathrin.

The substitution of the additional insecticide and/or further addition of other known active compounds, such as herbicides, fungicides, fertilisers or growth regulators, is also possible.

The invention also relates to a process for producing an oil-in-water emulsion formulation as described herein comprising the steps of:
a) preparing an organic phase comprising the phthalate(s), the avermectin(s) and optionally further auxiliaries in the organic phase;
b) preparing an aqueous phase comprising water, the emulsifier system and optionally further hydrophilic auxiliaries;
c) mixing the organic phase and the aqueous phase under agitation to obtain an oil-in-water emulsion.

As the skilled person will easily recognise, the order of addition of the various ingredients used in both the organic and aqueous phase is of minor importance. This also applies to the order of combining the organic phase with the aqueous phase. Some of the optionally auxiliaries may even be added after the mixing of the organic and aqueous phase. One skilled in the art will further recognise that any one of a variety of apparatus may be used to accomplish the mixing steps. Intensive homogenisation is not required. In either of the above steps, heat may be applied to ease the formation of a homogeneous phase.

The invention further relates to the use of oil-in-water emulsion formulations as described herein for the control of pests, said use comprise applying the emulsion, preferably in diluted form (e.g. aqueous diluted form), to the pests or to plants, soil, surfaces and the like infested with pests or likely to be occupied by pests. While such use is generally aimed at protection of crops against pests, other applications also form part of the present invention e.g. household uses and veterinary uses including pest control on pets. When used in crop protection, the formulations of the present invention can be used to fight pests such as for example aphids, mites, tics, nematodes, acaricides, roaches, ants and the like.

The formulations according to the invention show bioefficacy comparable to that of conventional EC formulations but at the same time avoids the use of large amounts of hazardous organic solvents and as such are more environmental and user friendly. Further, the formulations significantly reduce the degradation of the avermectin(s) also when exposed to light.

The formulations according to the invention have the following characteristics: A volume-surface mean diameter in the range 1-20 μm, preferably 1-10 μm, no distinct smell, high flash point and are white and free-flowing (200-55000 cP, preferably 200-25000 cP depending on the particular composition of the formulation) following preparation.

While concentrated formulations are more preferred as commercially available goods, the end consumer uses, as a rule, dilute compositions. Such compositions are part of the present invention.

The invention is illustrated by the following examples, which are provided solely for illustrative purposes and should not be considered limiting:

### EXAMPLE 1

1.90 g Abamectin (94.55%) is dissolved in 25 g dimethyl phthalate and a total amount of 6.8 g of preservative, sticker, thickener and co-solvent is added and dissolved. 73.3 g of aqueous phase consisting of a buffer agent, an anionic emulsifier (1.5% w/w of the emulsion) and water is prepared. The emulsification is performed in one of two ways, both resulting in an oil-in-water emulsion of comparable electric conductivity and volume-surface mean diameter of the emulsion droplets. 1) Under vigorous stirring (3000-4000 rpm), the aqueous phase is added to the organic phase and stirring is continued until the volume-surface mean diameter is in the range 1-20 μm. 2) Under vigorous stirring (3000-4000 rpm) the organic phase is added to the aqueous phase and stirring is continued until the volume-surface mean diameter is in the range 1-20 μm. Adjustment of pH and viscosity when relevant are done following the emulsification process. The preparations appear as white non-transparent emulsions.

### EXAMPLE 2

Abamectin 18 g/l oil-in-water emulsions containing various oil phases were prepared in accordance with the procedure outlined in example 1 using premium grade of inerts and an optimal combination of emulsifying agents in each emulsion produced. Only the necessary amount of organic solvents was applied in order to keep the Abamectin dissolved in the oil phase. The stirring speed during the emulsion formation was regulated such that the volume-surface mean diameter was in the range 1-20 su after production. Whereas examples A and B in table 1 are prepared according to the invention, examples C through K are comparative.

TABLE 1

| | | Example no. | | | | | |
|---|---|---|---|---|---|---|---|
| Ingredient | Ingredient function | A | B | C | D | E | F |
| Abamectin | Active substance | 1.64 | 1.61 | 1.66 | 1.46 | 1.94 | 1.621 |
| Diethyl phthalate | Solvent | 30.7 | | | | | |
| Diisononyl phthalate | Solvent | | 23-47 | | | | |
| Technical malathion | Solvent | | | 30 | | | |
| N-methylpyrrolidone | Solvent | | | | 3.5 | 4.2 | |
| Octanol | Solvent | | | | 3.9 | | |
| Norpar 15 (mineral oil) | Co-solvent | | | | | 0.9 | |
| Agnique ME 890 G (methylated fatty acid) | Solvent | | | | 10 | | |
| 1-hexanol | Solvent | | | | | 4.2 | |
| Genagen 4296 (dimethylamide of fatty acid) | Solvent | | | | | | 30.7 |
| Shell Fluid 2613 (mineral oil) | Co-solvent | | 6 | | | | |
| Propylene glycol | Anti freeze | 16 | | | | | 16 |
| Soprophor FLK (anionic) | Emulsifier | 1.6 | 1.5 | | | | 1.6 |
| Emulsifier Blend I (anionic and nonionic blend) | Emulsifier | | | 7.4 | | | |
| LFH (anionic) | Emulsifier | | | | 0.72 | | |
| Phenylsulphonate CA (anionic) | Emulsifier | | | | 1.1 | | |
| Emulsifier Blend II (anionic and nonionic blend) | Emulsifier | | | | | 6.7 | |
| BHT (2.6-di-tert-butyl-4-methyl phenol | Stabiliser | | | | | 0.18 | |
| Hydrogen peroxide | Stabiliser | | | 0.4 | | | |
| Rhodopol 23 (xanthan gum) | Thickener | 0.22 | 0.21 | | | | 0.22 |
| Carbopol 980 (polyacrylic acid) | Thickener | | | 0.4 | | | |
| Sipernat S22 (a silica) | Structure | 1.5 | | | | | 1.5 |
| Van gel 4% solution (clay) | Structure | 6.25 | | | | | 6.25 |
| Propyl parahydroxybenzoate | Preservative | 0.1 | 0.09 | | | | 0.1 |
| Citric acid dehydrate | pH-adjuster | 0.1 | 0.09 | 0.28 | | | 0.1 |
| Agrimer AL 10 (PVP derivative) | Sticker | 0.5 | 0.5 | | | | 0.5 |
| Rhodorsil 426R and Rhodorsil 416 (silicone oil) | Defoamer | 0.25 | | | | | 0.25 |
| Water up to | | 100 | 100 | 100 | 100 | 100 | 100 |
| pH of emulsion | | 4.0 | 3.2 | 5.0 | 2.5 | 6.7 | 4.2 |
| Abamectin content after storage for 14 days at 54° C. | | 1.61 | 1.58 | 1.48 | 0.03 | 1.59 | 1.506 |
| | | | (average) | | | | |
| | | (98.2) | (98.1) | (89) | (2) | (82) | (92.9) |

| | | Example no. | | | | |
|---|---|---|---|---|---|---|
| Ingredient | Ingredient function | G | H | I | J | K¹ |
| Abamectin | Active substance | 1.575 | 1.67 | 1.627 | 1.21 | 1.80 |
| Genagen 4166 (dimethylamide of fatty acid) | Solvent | 30.7 | | | | |
| Agsolex 8 (dimethylamide of fatty acid) | Solvent | | 30.7 | | | |
| Agsolex 12 (dimethylamide of fatty acid) | Solvent | | | 30.7 | | |
| Agnique ME 890 G (methylated fatty acid) | Solvent | | | | 7 | |
| Diisopropyl biphenyl | Solvent | | | | 3.8 | |
| Propylene glycol | Anti freeze | 16 | 16 | 16 | | |
| LFH (anionic) | Emulsifier | | | | 1.0 | |
| Phenylsulphonate CA | Emulsifier | | | | 0.8 | |
| Soprophor FLK (anionic) | Emulsifier | 1.6 | 1.6 | 1.6 | | |
| Rhodopol 23 (xanthan gum) | Thickener | 0.22 | 0.22 | 0.22 | | |
| Sipernat S22 (a silica) | Structure | 1.5 | 1.5 | 1.5 | | |
| Van gel 4% solution (clay) | Structure | 6.25 | 6.25 | 6.25 | | |
| Propyl parahydroxybenzoate | Preservative | 0.1 | 0.1 | 0.1 | | |
| Citric acid dehydrate | pH-adjuster | 0.1 | 0.1 | 0.1 | | |
| Agrimer AL 10 (PVP derivative) | Sticker | 0.5 | 0.5 | 0.5 | | |
| Rhodorsil 426R and Rhodorsil 416 (silicone oil) | Defoamer | 0.25 | 0.25 | 0.25 | | |
| Water up to | | 100 | 100 | 100 | 100 | |
| pH of emulsion | | 4.3 | 4.2 | 4.0 | 2.7 | |
| Abamectin content after storage for 14 days at 54° C. | | 1.467 | 1.505 | 1.485 | 0.09 | |
| | | (93.1) | (90.1) | (91.3) | (7.4) | (>97) |

Values in ( ) represents the remaining part of active ingredient after storage expressed as percentage of initial concentration.
¹Example K represents commercial Abamectin 18 g/l EC formulation.

### EXAMPLE 3

Oil-in-water emulsions of Abamectin as active ingredient and dimethyl phthalate as organic solvent are prepared as described in example 1 at a range of pH values and the stability of the active ingredient in accelerated storage tests at 54° C. and 70° C. for 14 days is determined, see table 2. The composition of the studied emulsion is as follows: 1.68% abamectin, 23.4% dimethyl phthalate, 5.6% co-solvent (Shell fluid 2613), 0.86% preservative, antifoam agent, sticker, thickener and citric acid, 1.5% anionic emulsifier (Soprophor FLK) and water up to 100%. pH adjusted using NaOH.

TABLE 2
Accelerated stability data for Abamectin oil-in-water using
dimethyl phthalte as organic solvent at different pH values.

| | | Content of abamectin | Content of abamectin |
|---|---|---|---|
| | | after storage for | after storage for |
| | Initial content | 14 days at 54° C. | 14 days at 70° C. |
| | of abamectin | In brackets | In brackets |
| pH | (% w/w) | % abamectin left | % abamectin left |
| 3.33* | 1.71 | 1.58 (92.4) | 1.40 (81.9) |
| 5.15 | 1.71 | 1.64 (95.9) | 1.59 (93.0) |
| 6.01 | 1.73 | 1.67 (96.5) | 1.62 (93.6) |
| 7.19 | 1.69 | 1.68 (99.4) | 1.66 (98.2) |
| 8.02 | 1.68 | 1.68 (100 ) | 1.68 (100 ) |

*pH not adjusted after emulsification

The stability of the active ingredient in the prepared EW formulation is increased by adjusting pH, resulting in an acceptable level of degradation of less than 2% at pH 7 and pH 8 even for storage at 70° C. for 14 days. For storage at 54° C. the pH need only be adjusted to pH 5 to obtain his improvement in stability.

### EXAMPLE 4

Oil-in-water emulsions of Abamectin as active ingredient and diethyl phthalate as organic solvent are prepared as described in example 1 at a range of pH values and the stability of the active ingredient in accelerated storage at 54° C. and 70° C. for 14 days is determined, table 3. The composition of the studied emulsion is as follows: 1.7% abamectin. 23.4% diethyl phthalate. 5.6% co-solvent (Shell fluid 2613), 0.86% preservative, antifoam agent. sticker, thickener and citric acid, 1.5% anionic emulsifier and water up to 100%. pH adjusted with NaOH

TABLE 3
Accelerated stability data for abamectin oil-in-water formulations
using diethyl phthalate as organic solvent at different pH values.

| | | Content of abamectin | Content of abamectin |
|---|---|---|---|
| | | after storage for | after storage for |
| | Initial content of | 14 days at 54° C. | 14 days at 70° C. |
| | abamectin | In brackets | In brackets |
| pH | (% w/w) | % abamectin left | % abamectin left |
| 3.34* | 1.70 | 1.52 (89.4) | 1.38 (81.2) |
| 5.00 | 1.70 | 1.65 (97.1) | 1.59 (93.5) |
| 5.95 | 1.67 | 1.67 (100) | 1.63 (97.6) |
| 7.04 | 1.72 | 1.70 (98.8) | 1.67 (97.1) |
| 8.05 | 1.71 | 1.69 (98.8) | 1.66 (97.1) |

*pH not adjusted after emulsification

The stability of the active ingredient in the prepared EW formulation is increased by adjusting pH, resulting in an acceptable level of degradation of less than 3% at pH 6 and above even for storage at 70° C. for 14 days. For storage at 54° C. the pH need only be adjusted to pH 5 to obtain this improvement in stability.

### EXAMPLE 5

Oil-in-water emulsions of abamectin as active ingredient and diisononyl phthalate as organic solvent is prepared as described in example 1 at a range of pH values and the stability of the active ingredient in accelerated storage at 54° C. and 70° C. for 14 days is determined (table 4). The composition of the studied emulsion is as follows (% w/w): 0.70% abamectin, 43.9% diisononyl phthalate, 5.6% co-solvent (Shell fluid 2613), 0.86% of preservative, antifoam agent, sticker, thickener and citric acid, 1.5% anionic emulsifier and water up to 100%. pH adjusted using NaOH

TABLE 4
Accelerated stability data for abamectin oil-in-water formulations
using diisononyl phthalate as organic solvent at different pH values.

| | | Content of abamectin | Content of abamectin |
|---|---|---|---|
| | | after storage for | after storage for |
| | Initial content of | 14 days at 54° C. | 14 days at 70° C. |
| | abamectin | In brackets | In brackets |
| pH | (% w/w) | % abamectin left | % abamectin left |
| 3.19* | 0.712 | 0.639 (89.7) | 0.491 (69.0) |
| 5.1 | 0.702 | 0.713 (100) | 0.702 (99.9) |
| 5.98 | 0.746 | 0.710 (95.1) | 0.679 (95.6) |
| 7.04 | 0.735 | 0.723 (98.3) | 0.716 (97.4) |
| 7.99 | 0.737 | 0.687 (93.2) | 0.637 (86.4) |

*pH not adjusted after emulsification

The stability of the active ingredient in the prepared EW formulation is acceptable in the pH range 5-7 even for storage at 70° C. for 14 days.

### EXAMPLE 6

An Abamectin 1.64% oil-in-water emulsion containing 30.7% diethyl phthalate and an Abamectin 1.78% microemulsion was applied on shaved rat skin mounted in Franz diffusion cells. The microemulsion contained, beside Abamectin, 22% cyclohexanone, 15% tristyrylphenol oxethylated with 20 moles of EO phosphorylated and neutralised with triethanolamine emulsifier, 3% sodium salt of an alkyldiglycol ether-sulfate, and 58% de-mineralised water (prepared according to the process set forth in U.S. Pat. No. 5,227,402—example 11) .

According to table 5, less Abamectin permeated through the shaved rat skin from the oil-in-water emulsion tan from the microemulsion, p<0.05, student's t-test). On average, 48.4 microgram and 17.8 microgram Abamectin permeated through the rat skin from the microemulsion and the oil-in-water emulsion, respectively. A low Abamectin permeation rate through mammal skin is highly desirable.

Another desirable property is a high flash point of the formulation as it can be handled with less risk. The flash point of the oil-in-water emulsion was determined to be higher than 95° C., for the microemulsion the flash point was 53° C. and the commercial available Abamectin EC formulation determined to be 70° C. (Petrotest, closed cup flash point tester, Pensky-Martens, Germany).

TABLE 5
Abamectin (μg) permeated through rat skin mounted in Franz
diffusion cells, 48 h after the formulations, i.e. ME ˜ microemulsion
and EW ˜ oil-in-water emulsion, were applied on the skin.

| | | | | Average | | |
|---|---|---|---|---|---|---|
| | ME | EW | Difference | Difference | STDEV | |
| Exp. No. | (μg) | (μg) | (μg) | (μg) | (μg) | t-value |
| 1 | 103.4 | 28.67 | 74.73 | 30.613 | 42.369 | 2.798 |
| 2 | 44.65 | 38.54 | 6.11 | | | |
| 3 | 19.74 | 46.06 | −26.32 | | | |
| 4 | 27.73 | 0 | 27.73 | | | |
| 5 | 49.82 | 6.11 | 43.71 | | | |
| 6 | 87.89 | 0 | 87.89 | | | |
| 7 | 70.5 | 23.5 | 47.0 | | | |
| 8 | 37.6 | 14.1 | 23.5 | | | |
| 9 | 23.5 | 79.9 | −56.4 | | | |
| 10 | 0 | 0 | 0 | | | |
| 11 | 0 | 4.7 | −4.7 | | | |
| 12 | 94 | 5.17 | 88.83 | | | |
| 13 | 42.77 | 11.75 | 31.02 | | | |
| 14 | 41.83 | 5.17 | 36.66 | | | |
| 15 | 83.19 | 3.76 | 79.43 | | | |
| Average | 48.441 | 17.829 | | | | |

t_{0.95} (14) = 1.761

### EXAMPLE 7 (COMPARATIVE)

The stability of Abamectin in water at various pH-values and temperatures was determined. 194.4 mg of abamectin was dissolved in 10 ml methanol and 1 ml of the solution transferred to 100 ml of de-mineralised water and a part of this was transferred to a buffer solution. The sample was kept in the dark and the solution analysed using a HPLC. Results are provided in table 6.

TABLE 6
Degradation of Abamectin in water at various pH-values and temperatures.

| | Time of measurement | Abemectin concentration (ppm) | | |
|---|---|---|---|---|
| Temp (° C.) | (days) | pH 4.0 | pH 7.0 | pH 9.0 |
| 50 | Initial | 3.495 | 3.327 | 3.555 |
| | 7 | 1.054 | 2.952 | 1.265 |
| | 14 | 0.383 | 2.780 | 0.519 |
| | 21 | 0.123 | 2.194 | 0.205 |
| | 28 | 0.0609 | 1.949 | 0.0628 |
| 25 | Initial | 3.495 | 3.327 | 3.555 |
| | 7 | 3.130 | 3.188 | 3.005 |
| | 14 | 2.782 | 3.040 | 2.596 |
| | 21 | 2.566 | 2.829 | 2.380 |
| | 28 | 2.524 | 2.676 | 2.287 |

Buffer pH 4: Potassium biphthalate/NaOH;
pH 7: Sodium phophate/Potassium phosphate;
pH 9: Sodium tetraborate.

### EXAMPLE 8 (COMPARATIVE)

The stability of Abamectin in water exposed to light at various pH-values was determined. 194.4 mg of abamectin was dissolved in 10 ml methanol and 1 ml of the solution transferred to 100 ml of demineralised water and a part of this transferred to a buffer solution. The solution was exposed to light (5000-6000 lux) at 25° C. and analysed using a HPLC. Results are provided in table 7.

TABLE 7
Degradation of Abamectin in water at various pH-values with
or without light exposure at 25° C.

| | Time of measurement | Abemectin concentration (ppm) | | |
|---|---|---|---|---|
| Condition | (days) | pH 4.0 | pH 7.0 | pH 9.0 |
| Light | Initial | 3.495 | 3.327 | 3.555 |
| | 7 | 2.923 | 2.941 | 3.163 |
| | 14 | 2.332 | 2.529 | 2.810 |
| | 21 | 1.961 | 2.223 | 2.360 |
| | 28 | 1.666 | 2.034 | 2.173 |
| Dark | Initial | 3.495 | 3.327 | 3.555 |
| | 7 | 3.130 | 3.188 | 3.005 |
| | 14 | 2.782 | 3.040 | 2.596 |
| | 21 | 2.566 | 2.829 | 2.380 |
| | 28 | 2.524 | 2.676 | 2.287 |

Buffer pH 4: Potassium biphthalate/NaOH;
pH 7: Sodium phophate/Potassium phosphate;
pH 9: Sodium tetraborate.

### EXAMPLE 9

Oil-in-water emulsions, which contained either 0.85% Abamectin and 3.55% Acrinathrine, formulation I, or 0.22% Abamectin and 6.87% Acrinathrine, formulation II, were prepared. The manufacturing procedure outlined in example 1 was followed strictly, and the inert ingredients content in the present mixture formulations were as outlined in table 1, example A.

According to an accelerated stability study, the chemical stability of both Acrinathrine and Abamectin was excellent in the present mixture formulations. Results are provided in table 8.

TABLE 8
Chemical stability of Acrinathrine and Abamectin in oil-in-water emulsions,
diethylphthalate was applied as solvent for both active ingredients in the emulsions.

| | | | Content of | Content of |
|---|---|---|---|---|
| | Initial content | Initial content | Acrianthrine after | Abamectin after |
| | of | of | storage for 14 days | storage for 14 days |
| | Acrinathrine | Abamectin | at 54° C. | at 54° C. |
| Formulation | % w/w | % w/w | % w/w | % w/w |
| I | 3.55 | 0.85 | 3.55 | 0.83 |
| II | 6.87 | 0.22 | 6.87 | 0.22 |

### EXAMPLE 10

Abamectin oil-in-water emulsions were prepared applying the manufacturing procedure described in Example 1. A mineral oils Shell Fluid 2613, or a spreading agent, Lutensol A07, were included in the organic phase and the water phase of the emulsions, respectively.

The efficacy of the formulations was measured on Tetranychus urticae mites applying a greenhouse test. The diluted formulations were sprayed on bean plants in a spray cabinet and mites were transferred to the plants right after the leaf surfaces were dry.

According to the efficacy data in table 9, the inclusion of mineral oil, Shell Fluid 2613, or the spreading agent, Lutensol A07, improved the activity of the Abamectin oil-in-water emulsion.

TABLE 9
Efficacy (ED 50 g/ha) of abamectin oil-in-water emulsions in a foliage
greenhouse test on bean plants against Tetranychus urticae.

| Formulation/ | Content | ED 50 | Confidence interval |
|---|---|---|---|
| Ingredients | (% w/w) | (g/ha) | (95%) |
| A: | | | |
| Abamectin | 1.706 | 10.9 | 3.4-35.3 |
| Diethyl phthalate | 28.7 | | |
| Soprophor FLK | 1.5 | | |
| Rhodopol 23 | 0.21 | | |
| Propyl para-hydroxy-benzoate | 0.09 | | |
| Citric acid dihydrate | 0.09 | | |
| Agrimer AL 10 | 0.5 | | |
| Water up to | 100 | | |
| B: | | | |
| As A | 3 | 5.5 | 3.2-9.2 |
| Shell Fluid 2613 | | | |
| C: | | | |
| As A | 6 | 1.6 | 0.7-3.6 |
| Shell Fluid 2613 | | | |
| D: | | | |
| As A | 2 | 6.5 | 3.6-11.6 |
| Lutensol A07 | | | |
| E: | | | |
| As A | 4 | 4.8 | 2.8-8.1 |
| Lutensol A07 | | | |
| F: | | | |
| As A | 6 | 2.9 | 1.6-5.5 |
| Lutensol A07 | | | |
| Commercial abamectin | — | 5.4 | 2.7-10.8 |
| 18 g/l EC formulation | | | |

### EXAMPLE 11

Abamectin oil-in-water emulsions were prepared applying the manufacturing procedure outlined in Example 1. Emulsions were prepared by adding the water phase to the organic phase or vice versa. After preparation the pH of the emulsions were adjusted to 5.0 with 1M NaOH, and conductivity measurements were done in order to ensure the finished products were oil-in-water and not water-in-oil emulsions.

The composition of the emulsions is tabulated below, table 10. According to the chemical stability data in table 10, both manufacturing procedures, i.e. adding water phase to oil phase or adding oil phase to water phase, gave formulations having excellent chemical stability. In addition, inclusion of a mineral oil, e.g. Shell fluid 2613, appeared to improve the chemical stability of abamectin in the emulsions. Biological activity of the formulations against Tetranychus urticae mites was studied as described in example 10. Both the fresh formulations and formulations stored for 14 days at 54° C. had excellent activity against the mites.

TABLE 10
Chemical stability data and efficacy data (ED 50 g ai/ha) for abamectin oil-
in-water emulsions. The efficacy was measured in a foliage greenhouse test
on bean plants against Tetranychus urticae.

| | | | | ED 50 g |
|---|---|---|---|---|
| | | | | ai/ha |
| | | | | Confidence interval |
| | | | % abamectin | 95% |
| | | | left after | Fresh product |
| | Content | Emulsion | storage for 14 | (Product stored for |
| Formulation/Ingredient | (% w/w) | technique | days at 54° C. | 14 days at 54°) |
| A: | | | | |
| Abamectin | 1.682 | Oil phase added | 97.8 | 1.28 |
| Diethyl phthalate | 28.7 | to water phase | | 0.58-2.61 |
| Soprophor FLK | 1.5 | | | (1.79) |
| Rhodopol 23 | 0.21 | | | (0.80-4.90) |
| Propyl parahydroxy- | 0.09 | | | |
| benzoate | | | | |
| Citric acid dihydrate | 0.09 | | | |
| Agrimer AL 10 | 0.5 | | | |
| Water up to | 100 | | | |
| B: | | | | |
| As A | | Water phase | 97.6 | 0.20 |
| | | added to oil phase | | 0.01-0.65 |
| | | | | (0.68) |
| | | | | (0.23-1.59) |
| C: | | | | |
| As A | 6 | Oil phase added | 98.0 | 0.44 |
| Shell Fluid 2613 | | to water phase | | 0.12-1.07 |
| | | | | (0.30) |
| | | | | (0.07-0.73) |
| D: | | | | |
| As A | 6 | Water phase | 97.9 | 0.89 |
| Shell Fluid 2613 | | added to oil phase | | 0.35-2.68 |
| | | | | (0.43) |
| | | | | (0.10-1.14) |
| E; | | | | |
| As A | 12 | Oil phase added | 98.5 | 1.59 |
| Shell Fluid 2613 | | to | | 0.74-3.49 |
| | | Water phase | | (1.31) |
| | | | | (0.55-4.16) |
| F: | | | | |
| As A | 12 | Water phase | 98.8 | 1.01 |
| Shell Fluid 2613 | | added to oil phase | | 0.43-2.39 |
| | | | | (1.19) |
| | | | | (0.51-3.42) |

### EXAMPLE 12

An Abamectin 18 g/l oil-in-water emulsion containing diethyl phthalate as organic solvent was prepared applying the method in example 1 using premium grade of inerts and an emulsifying agent. The stirring speed during the emulsion formation was regulated such that the volume-surface mean diameter was in the range 1-20 μm after production.

The efficacy of the formulations was measured in a greenhouse assay and in a field assay. For the greenhouse assay the diluted formulations were sprayed on bean plants in a spray cabinet and mites were transferred to the plants right after the leaf surfaces were dry. The formulation proved comparable to a conventional emulsifiable concentrate (EC) formulation of abamectin in toxicity towards two spotted spider mites (Tetranycus urticae) on bean plants in a greenhouse assay as indicated by the obtained ED50 values reported in table 11. Against Beet Armyworm (Spodoptera exigua) on tradescantis leaves the EW formulation proved to be even more toxic than the conventional EC formulation in the greenhouse assay.

TABLE 11
Composition and toxicity data for an 18 g/l Abamectin oil-in-water
formulation with diethyl phthalate as organic solvent obtained in a
greenhouse assay. Data for an abamectin EC formulation are
included for the sake of comparison. The 95% confidence interval
for each value is given in brackets.

| | ED50 of | ED50 of |
|---|---|---|
| Composition | Tetranycus urticae | Spodoptera exigua |
| Inerts applied (% w/w) | on bean plants | on tradescantis leaves |
| Abamectin 1.72 | 3.7 (2.1-6.5) | 2.36 (0.2-6.6) |
| Diethyl phthalate 28.7 | | |
| Emulsifier 1.5 | | |
| Preservative, antifoam, | | |
| sticker, thickeners, buffer | | |
| agent 0.86 | | |
| Water up to 100 | | |
| Abamectin 18 g/l EC | 3.6 (1.8-7.1) | 13.94 (8.16-25) |
| commercial | | |

Field trials were also conducted with the oil-in-water formulation showing that the EW and the commercial EC formulations had comparable efficacies against two spotted spider mites (Tetranychus urticae) on aubergine (Solanum melongena L.), as reported in table 12.

TABLE 12
Composition and efficacy of an 18 g/l Abamectin oil-in-water
formulation with diethyl phthalate as solvent obtained in field
trials. Target specie was two spotted spider mites (Tetranychus urticae)
and the crop used was aubergine (Solanum melongena L.).

| | | Abamectin 1.72 | |
|---|---|---|---|
| | | Diethyl phthalate 28.7 | |
| | | Emulsifier 1.5 | |
| Composition | | Preservative, antifoam, sticker, | Abamectin |
| Inerts applied | | thickeners, buffer agent 0.86 | 18 g/l EC |
| (% w/w) | | Water up to 100 | commercial |
| 1 | DAA | Satisfactory | Satisfactory |
| 3 | DAA | Good to excellent | Good to excellent |
| 7 | DAA | Good to excellent | Good to excellent |
| 14 | DAA | Good to excellent | Good to excellent |
| 21 | DAA | Good to excellent | Good to excellent |
| 28 | DAA | Good to excellent | Good to excellent |
| 3 | DAB | Good to excellent | Good to excellent |
| 7 | DAB | Good to excellent | Good to excellent |
| 14 | DAB | Good to excellent | Good to excellent |
| 21 | DAB | Good to excellent | Good to excellent |

Results for the conventional abamectin EC formulation are included for the sake of comparison.
DAA = days after application,
DAB = days after second application, which took place 28 days after first application, i.e. 28 DAA.
The data (provided as efficacy in Abbott %) are divided into three intervals: <60% insufficient effect, 60-85% satisfactory effect and >85% good to excellent effect.

### EXAMPLE 13

Oil-in-water emulsions of Abamectin as active ingredient and dimethyl phthalate as organic solvent are prepared as described in example 1 using different co-solvents, pH adjusted to 7 using NaOH. Results are provided in table 13.

TABLE 13

Amount (w/w %)

| Ingredient | A | B |
|---|---|---|
| Organic phase: | | |
| Shell Fluid 2613 | 6.0 | |
| Sunflower Oil | 3.5 | 14.0 |
| Abamectin | 1.64 | 1.60 |
| Propyl parabenzoat | 0.1 | 0.1 |
| Agrimer AL 10 | 0.5 | 0.5 |
| dimethyl phthalate | 23.4 | 23.3 |
| Rhodopol 23 | 0.2 | 0.2 |
| Water phase: | | |
| Citric acid monohydrat | 0.1 | 0.1 |
| Soprophor FLK | 1.5 | 1.5 |
| Demineralised water up to | 100 | To 100 |
| Abamectin content after | 1.57 | 1.54 |
| storage for 14 days at 54° C. | (95.7) | (96.3) |

### EXAMPLE 14

An oil-in-water formulation of Abamectin is prepared according to example 1. The composition of the emulsions is as follows: 1.8% Abamectin, 25.0% dim ethyl phthalate, 0.9% preservative, antifoam agent, sticker, thickener and buffer, 6% co-solvent (Shell fluid 2613), 6.6% total of two anionic emulsifiers (Soprophor FLK and LFS) and water up to 100%. A microemulsion (I) of Abamectin also containing lidocaine is prepared according to European patent no 45655-A2, example 1. For each emulsion 1 ml of emulsion is transferred to 4 crystallisation bowls and left to dry in darkness. Two bowls are exposed to light from a xenon lamp (400 lux) for 10 hours and two bowls are left in darkness also for 10 hours. After exposure the formulation is dissolved in 10 ml ethanol and the remaining amount of Abamectin is determined by HPLC analysis. The experiment is repeated using a commercial 18 g/l EC formulation of Abamectin for comparison. Table 14 shows the stability of both prepared emulsions along with results from the conventional EC formulation of Abamectin. The table indicates that the stability of Abamectin under the exposure of light is greater for the emulsion prepared according to example 1 than for the comparative microemulsion and the commercial EC formulation.

TABLE 14
Stability of abamectin when exposed to light from a xenon lamp for a
period of 10 hours. The applied amount of Abamectin corresponds
to a concentration of 18 ppm in the final analysis.

| | Content of | Content of | |
|---|---|---|---|
| | Abamectin after | Abamectin after | |
| | 10 hours in | 10 hours light | % Abamectin left |
| | darkness | exposure | after exposure to |
| | (ppm) | (ppm) | light |
| ME (EP | 12.2 | 6.4 | 52.9 |
| 45655-A2) | | | |
| EC commercial | 16.3 | 12.1 | 74.0 |
| EW | 20.3 | 18.1 | 89.2 |

The results are average of two tests in each case.

1. An oil-in-water emulsion formulation comprising
a) one or more pesticidal active ingredients selected among avermectins
b) one or more organic solvents selected among phthalates
c) an emulsifier system comprising one or more surfactants
d) water

2. The oil-in-water emulsion formulation according to claim 1, essentially consisting of
a) one or more pesticidal active ingredients selected among avermectins
b) one or more organic solvents selected among phthalates
c) an emulsifier system comprising one or more surfactants
d) optionally one or more further auxiliaries selected from the groups of co-solvents, UV-protectants, pH-adjusters, thickeners, film-forming agents, antifreeze agents, preservatives, antifoaming agents, spreading agents, stickers, wetting agents, structuring agents and additional insecticides.
e) water.

3. The formulation according to claim 1, wherein the avermectin(s) is selected among Abamectin, Aversectin C, Doramectin, Emamectin (optionally in the form of its benzoate salt), Eprinomectin, Ivermectin, Lepimectin and Selamectin.

4. The formulation according to claim 3, wherein the avermectin is Abamectin.

5. The formulation according to claim 1, wherein the phthalate(s) is selected among dialkyl or alkyl aryl esters of 1,2-benzenedicarboxylic.

6. The formulation according to claim 5, wherein the phthalate is selected among dimethyl phthalate, diethyl phthalate and diisononyl phthalate.

7. The formulation according to claim 2, wherein the additional insecticide(s) is chosen among pyrethroids.

8. The formulation according to claim 7, wherein the pyrethroid is acrinathrin.

9. The formulation according to claim 2, wherein the pH-value of the emulsion prior to dilution is between 3-10.

10. The formulation according to claim 9, wherein the pH-value is between 4-9.

11. The formulation according to claim 10, wherein the pH-value is between 5-8.

12. The formulation according to claim 2, wherein one or more co solvents is included and preferably selected among mineral oils and vegetable oils.

13. A process for producing an oil-in-water emulsion formulation as claimed in claim 1, comprising the steps of:
a) preparing an organic phase comprising the phthalate(s), the avermectin(s) and optionally further auxiliaries in the organic phase;
b) preparing an aqueous phase comprising water, the emulsifier system and optionally further hydrophilic auxiliaries;
c) mixing the organic phase and the aqueous phase under agitation to obtain an oil-in-water emulsion.

14. A method for the control of pests comprising applying an oil-in-water emulsion formulation as claimed in claim 1, to pests, to plants, to animals, soil or surfaces infested with pests.

15. The method according to claim 14, wherein the formulation is applied in diluted form.

16. The method according to claim 15, wherein the formulation is applied to plants.
